(19) United States
(12) Patent Application Publication
(10) Pub. No.: US 2016/0219444 A1
(43) Pub. Date: Jul. 28, 2016

(54) System and Method for Analysis Of Blocking Interferers

(71) Applicant: KATHREIN-Werke KG, Rosenheim (DE)

(72) Inventors: Evgenij Tsaregorodtsev, Ulm (DE); Johannes Schlee, Ulm (DE)

(21) Appl. No.: 15/007,306

(22) Filed: Jan. 27, 2016

(30) Foreign Application Priority Data
Jan. 27, 2015 (GB) 1501325.3

(51) Int. Cl. H04W 24/02; H04W 28/04; H04B 7/02; H04W 16/20

(52) U.S. Cl. CPC H04W 24/02; H04W 16/20; H04W 28/048; H04B 7/022; H04W 88/085

(57) ABSTRACT

A method for analysing blocking activity in a distributed antenna system (5) is disclosed. The method comprises detection (220) of at least one blocker signal (50b) one antenna element (10a-c), logging (240) a plurality of data values associated with the detected blocker signal (50) and storing (250) the recorded plurality of data values in an activity database (80).

### CROSS-REFERENCE TO RELATED APPLICATIONS

This application is related to UK patent applications numbers GB 1414280.6, GB 1414288.9 and GB 1414283.0. This application also is related to and claims priority to UK patent application number GB 1501325.3. The foregoing applications are hereby incorporated by reference in their entirety.

### BACKGROUND OF THE INVENTION

1. Field of the invention

The invention relates to a system and a method for analyzing and alleviating a blocking activity in a distributed antenna system.

2. Brief Description of the Related Art

The use of mobile communications networks has increased substantially over the two decades. Operators of the mobile communications networks have increased the number of base stations in order to meet an increased demand for service by users of the mobile communications networks. The operators of the mobile communications network need to reduce the running costs of the base station as well as improve the coverage of the base station. One option to do this is to implement systems for relaying the telecommunications signals of the mobile communication network as a distributed antenna system (DAS).

The constantly increasing capacity demand in wireless communications and the fact that about 80% of the traffic on the mobile communication system is generated indoors requires new methods to provide flexible signal relaying systems to enable efficient spectrum usage. When indoor traffic is handled with a pure outdoor macro coverage solution, the signal penetration and the signal quality is poor in the indoor environment. Indoor coverage solutions with distributed antenna systems help overcome this issue, but the increasing capacity demand require more advanced indoor solutions beyond pure coverage systems

Active distributed antenna systems (DAS) have been developed to improve the coverage indoors. These distributed antenna systems have the capability of dynamic traffic/cell switching. The radio frequency (RF) signals in the DAS are communicated between a central hub and a plurality of remote units to which antenna elements are connected. The central hub is connected to one or more of the base stations. In the DAS, the coverage of a single cell is not necessarily provided by a single one of the remote units. The plurality of the remote units relays the same telecommunication signal of the cell throughout the coverage area of the cell. The coverage area of the cell is the sum of the individual coverage areas of each ones of the remote units, which are assigned to the cell. In the case of a plurality of antenna elements being connected to one remote unit, the coverage area of the cell is the sum of the individual antenna element coverage areas connected to the remote unit, which is assigned to the cell.

The DAS may be used to provide coverage and capacity inside a building, as well as coverage and capacity in metropolitan or campus areas.

The applicant's co-pending patent applications No. GB 1414280.6, GB 1414288.9 and GB 1414283.0 describe a distributed antenna system in which the remote units and the antenna elements are distributed inside a building. The use of the distributed antenna system in the building means that attenuation of an uplink path between a mobile station, such as a handset or smartphone, is significantly lower than to a macro base station, located outside of the building. The DAS enables connection quality to be maintained, even when the user of the mobile station is moving within the building. On the other hand, the lower attenuation in the uplink path can cause high interference levels on the receiver inputs and block the uplink path completely.

In a distributed antenna system, several signals from the antenna elements in the uplink path are combined to form a single combined signal that is sent to the base station. Suppose now that a blocker signal is active at one single antenna element. A blocker signal is a signal that is so strong that it will drown out other telecommunications signals in the same frequency band. The combined signal, including the blocker signal, is sent to the base station and can saturate the receiver at the base station. This saturation can be avoided by detection of the blocker signal and suppression of the blocker signal in the frequency band at the remote unit. The combined signal will then not saturate the receiver in the base station.

This blocking of the blocker signal is generally achieved by an automatic gain control (AGC) algorithm located in the remote unit attached to the antenna element. The AGC algorithm attenuates the signal in a receiver input frequency band specific to the blocker signal and thus protects the remote unit against saturation. The suppression of the blocker signal in the frequency band means that the combined signal at the base station will no longer contain the blocker signal. However, the increase of the attenuation at the remote unit has the disadvantage that the sensitivity of the remote unit for all signals in all bands is reduced (due to the attenuation). Thus, the quality of service is reduced for the mobile station, and in particular, it may no longer be possible to process useful, i. e. non-blocking (signals).

### SUMMARY OF THE INVENTION

The disclosure teaches a method for analyzing blocking activity in a distributed antenna system. The method comprises detection of at least one blocker signal at one of the antenna elements in the distributed antenna system and measuring a plurality of data values associated with the detected blocker signal. These measured data values are recorded in an activity database and can be used by a network operator (also planner) to determine likelihood of a presence of the blocker signal. The recording of the data values enables, for example, a re-planning or optimisation of the distributed antenna system and a surrounding network. The network operator can also increase signal power on other frequency bands unaffected by the blocker signal and/or turn off antenna elements most susceptible to the blocker signals at certain times of the day or night.

The data values recorded in the activity database include, but are not limited to, the frequency band containing the blocker signal as well as its carrier frequency, time of occurrence, power lever of the blocker signal and the designation of the antenna element at which the blocker signal is detected.

The network operator can access the activity database and analyse the data in the activity database and/or create display graphic files, which are indicative of the blocking activity. This enables the network operator to analyse and substantially eliminate the blocker signals in the distributed antenna system or re-plan or optimise coverage using the distributed antenna system.

This disclosure also teaches a system for analyzing the blocking activity having a plurality of antenna elements, connected to a plurality of remote units, a monitor for monitoring presence of a blocker signal in one or more of the plurality of the antenna elements, a data logger for logging the plurality of data values associated with the blocker signal and a data storage device for storing the logged plurality of data values.

The use of the method for alleviating effects of the blocker signal is also disclosed.

### DESCRIPTION OF THE FIGURES

For a more complete understanding of the present invention and the advantages thereof, reference is now made to the following description and the accompanying drawings, in which:

FIG. 1A shows a simplified aspect of a distributed antenna system of the disclosure.

FIG. 1B shows a further aspect of the distributed antenna system of the disclosure in which the distributed antenna system is connected to two base stations.

FIG. 2 shows a flow diagram of the method for analyzing blocking activity.

### DETAILED DESCRIPTION OF THE INVENTION

The invention will now be described on the basis of the drawings. It will be understood that the embodiments and aspects of the invention described herein are only examples and do not limit the protective scope of the claim in any way. The invention is defined by the claims and their equivalents. It will be understood that features of one aspect or embodiment of the invention can be combined with a feature of a different aspect or aspects and/or embodiment of the invention.

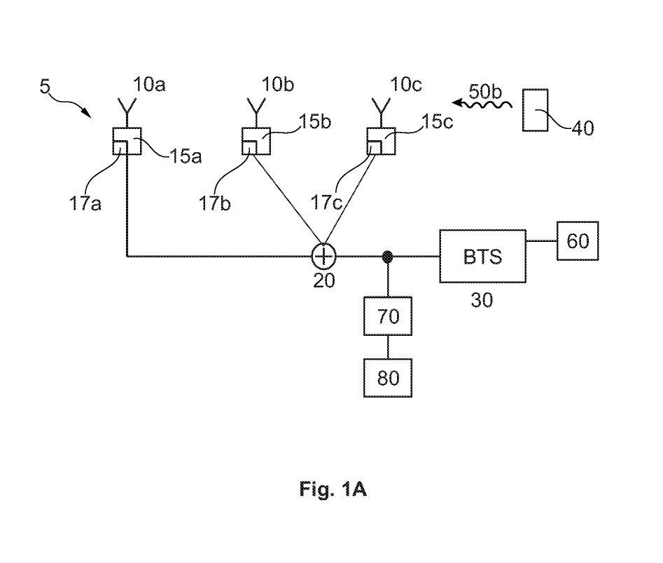

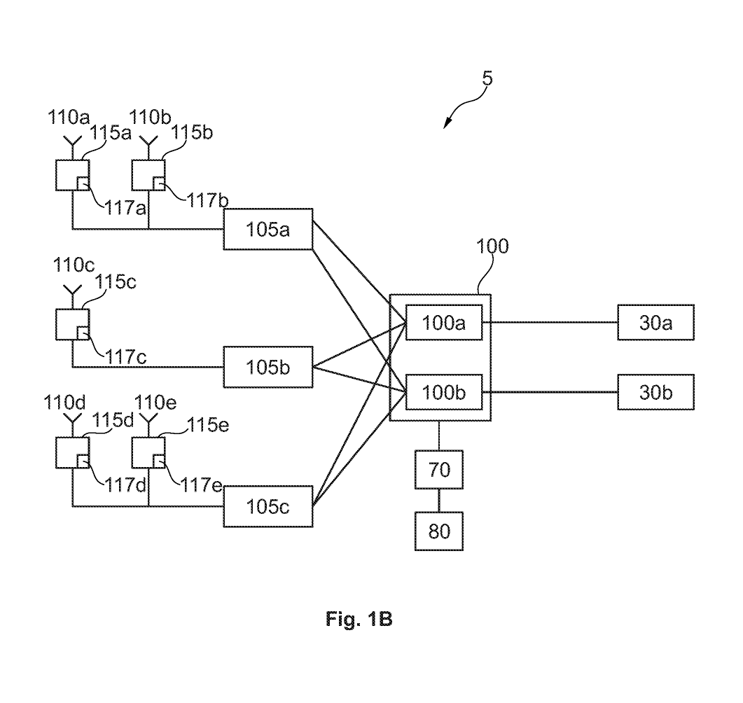

FIG. 1 shows a first simplified aspect of a distributed antenna system 5 incorporating the features of this disclosure. The distributed antenna system 5 has a plurality of antenna elements 10a-c connected to a corresponding remote unit, including radio unit, 15a-c. The antenna elements 10a-c are distributed, for example, throughout a building or over a campus or metropolitan area, but this is not limiting of the invention. In this first simplified aspect of the distributed antenna system 5, the received signals at the antenna elements 10a-c are processed by the remote units 15a-c and sent to a combiner 20 from which a combined signal is sent to a base station 30.

The remote units 15a-c have a limiter 17a-c. The limiter 17a-c is used to increase the strength of weak signals, if necessary but often is not required and to attenuate any strong received signals beyond a threshold value in certain frequency bands received by the antenna elements 10a-c. The attenuation of the strong received signals ensures that these strong received signals do not saturate the receiver in the remote units 15a-c or at the base station 30.

The term base station 30 in this disclosure encompasses not only base transceiver stations, as known in the GSM protocol, but also Node B known in the UMTS protocol, e Node B in the LTE protocol, and similar units in other wireless protocols.

A monitor 70 is connected to the distributed antenna system 5 and an activity database 80 is connected to the monitor 70. The monitor 70 and the activity database 80 may be positioned within the distributed antenna system 5 in the building or may be remotely located at, for example, an operator's or network planner control center 60. The monitor 70 and the activity database 80 do not need to be co-located.

Suppose now that a mobile station 40 transmits a signal, which is very strong and will be termed a “blocker signal 50b”. The blocker signal 50b can saturate the receiver in the remote unit 15a-c. The limiter 17a-c attenuates the frequency band in which the blocker signal 50b is emitted.

The information about the blocker signal 50b, the carrier frequency, its frequency band, time and date and other data values is picked up by the monitor 70 and stored in the activity database 80. The activity database 80 is provided with an interface so that the operator or network planner can access the data values in the activity database 80 for analysis. The data values recorded in the activity database 80 include, but are not limited to, the carrier frequency and the frequency band in which the blocker signal 50b occurs, a time stamp indicating the time at which the blocker signal 50b occurs, the power level of the blocker signal 50b and the designation of the antenna element 10a-c at which the blocker signal 50b is received.

Generally, the monitor 70 will be inactive. The monitoring of the distributed antenna system 5 by the monitor 70 will only be triggered when the blocker signal 50b reaches a pre-defined power level. This can occur, for example, when the limiter 17a-c is switched on, implying that the remote unit 15a-c would be otherwise saturated. The carrier frequency of the blocker signal 50b in the frequency band can be identified by use of a frequency analysis in the remote unit 15a-c or by carrying out a frequency analysis of all of the combined signals for all of the antenna elements 10a-c. The frequency analysis will provide the power level of the blocker signal 50b and the center frequency of the blocker signal 50b. It would also be possible to determine the center frequency and power of a signal having the second highest power level in the distributed antenna system 5.

In one aspect of the invention, the monitor 70 is only switched on when the blocker signal 50b is detected. In another aspect of the invention, the monitor 70 periodically monitors the distributed antenna system 5. The monitor 70 is therefore not continually switched on and recording data values. This reduces the amount of data actually stored in the database 80.

FIG. 1B shows a further aspect of the invention in which two base stations 30a and 30b are connected to a central hub 100 in the distributed antenna system 5. The central hub 100 has a first hub module 100a and a second hub module 100b. Each one of the base stations 30a and 30b is connected to one of the first hub module 100a or the second hub module 100b. As explained in the Applicant's co-pending application, GB 1414280.6, the number of the base stations 30a, 30b and the hub modules 100a, 100b is not limiting of the invention. It will be appreciated that, in the aspect depicted in FIG. 1B, there is a risk that a strong signal from a mobile station 40 connected to one of the network operators operating one of the base station 30a or 30b could potentially block out other mobile stations 40 connected to other network operators operating the other one of the base station 30a or 30b.

The central hub 100 is connected to a distribution system having a plurality of expansion units, including coverage area modules 105a-c. One of more of the remote units 115a-e are connected to one or more expansion units 105a-c to which a plurality of antenna elements 110a-e are assigned. The one or more expansion units 105a-c are adapted to pass the same signals to the connected ones of the remote units 115 a-e and the corresponding antenna elements 110a-e. The communication between the central hub 100 and the expansion units 105 a-c is, in one aspect of the invention, in the digital domain and is reconfigurable. A digital to analogue conversion is provided within the expansion units 105 a-c and the communication between the expansion units 105a-c and the plurality of antenna elements 110a-e is, in one aspect of the invention, in the analog domain. The connection between the central hub 100 and the plurality of expansion units 105 a-c is reconfigurable. The one or more remote units 115a-e have a corresponding limiter 117a-e which functions, as described earlier, to attenuate any blocker signal 50b detected as explained earlier. The central hub 100 and the expansion units 105a-c enable telecommunications signals from the base stations 30a and 30b to be distributed through the distributed antenna system 5. As described in the applicant's co-pending patent application No. GB1414280.6 the distributed antenna system 5 is highly flexible and allows a reconfiguration of the coverage area, if one or more of the remote units 115a-e are saturated because of the blocker signal 50b.

The monitor 70 in FIG. 1B is connected to the central hub 100 for monitoring the blocking signals as described before in the digital domain. In this configuration, an analog monitoring is also possible.

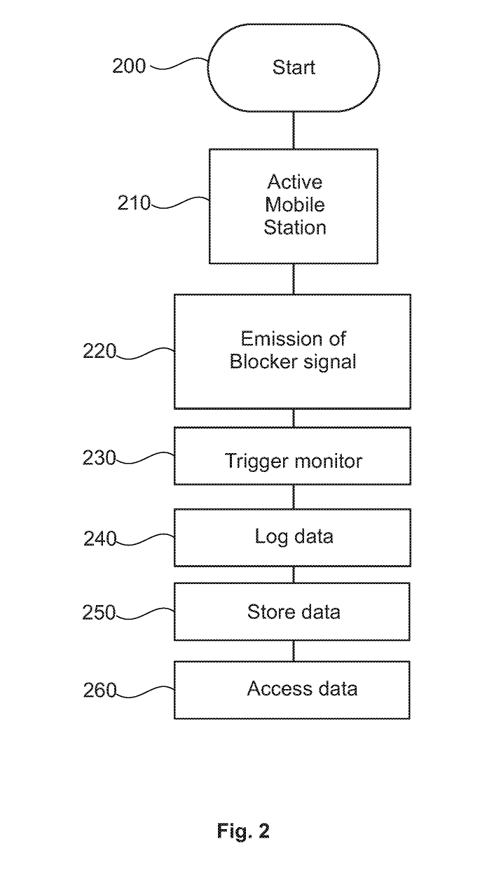

FIG. 2 shows a flow diagram illustrating the method for analyzing blocker activity in the distributed antenna system 5. One or more of the mobile stations 40 is active in step 210. For some reason, one of the mobile stations 40 emits in step 220 a strong signal 50b, which would saturate the receiver in the remote unit 15a-c or the base station 30 and is therefore the blocker signal 50b. The emission of the blocker signal 50b in step 220 triggers the monitor 70. In step 240, any data values associated with the blocker signal 50b can be recorded and these recorded data values are stored in step 250 in the activity database 80.

The operator of the distributed antenna system 5 (or a network operator) can access the stored data values in step 260 and carry out any remedial work as necessary.

The accessed data values can be used to create graphic files to illustrate the operation of the distributed antenna system 5 for analysis by the user. Statistical algorithms can be used to analyse the stored data values.

The remedial work could include blocking receipt of all of the blocker signals 50b from all of the mobile stations 40 in a particular frequency band at an affected one of the antenna elements 10a-c or at all of the antenna elements 10a-c over an entire coverage area. The blocking of the blocker signals 50b in this frequency band means that the limiter 17a-c is switched to avoid saturation of the remote unit 15a-c. It would be possible to switch only that limiter 17a-c for the affected one of the antenna elements 10a-c or to switch all of the limiters 17a-c for all of the antenna elements 10a-c over the entire coverage area. The other signals 50 received in other frequency bands are not attenuated, which will save transmission power and ensure good transmission quality in the other frequency bands.

It is possible that the remedial work could be time-based, i.e. only is required during certain times of the day. For example, if the activity database 80 reports that the blocker signal 50b is only received during working hours, then the operator or network planner can ensure that receipt of the signals from the particular frequency band including the blocker signal 50b is only carried out during working hours. Signals in other frequency bands will be received normally.

The network operator might also be able to detect that the blocker signal 50b occurs because one of the mobile stations 40 inside the building is connected to the (outdoor) macro coverage area and transmits a strong signal in the uplink path due to the (inevitable) attenuation of the signal through the building's walls. In this case, the operator may attempt to “capture” the mobile station 40 by causing the base station 30 to transmit a signal in a downlink path from one of the remote units 15a-15c near the mobile station 40 so that the mobile station 40 changes the cell to which the mobile station 40 is connected.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for analysing blocking activity in a distributed antenna system comprising:
detection of at least one blocker signal at at least one antenna element in the distributed antenna system;
logging a time stamp and a plurality of data values associated with the detected at least one blocker signal; and
storing the recorded plurality of data values and the time stamp in an activity database.

2. The method of claim 1, wherein the plurality of data values comprise at least one of a frequency band, a carrier frequency, a time stamp, a power level and an antenna element designation.

3. The method of claim 1, further comprising:
accessing the recorded plurality of data values; and
performing at least one of statistical analysis or creation of graphic files, being indicative of the blocking activity.

4. The method of claim 3, further comprising:
attenuating the at least one blocker signal in at least one remote unit connected to the at least one antenna element, whilst leaving other signals unattenuated.

5. The method of claim 4, wherein the attenuating of the at least one blocker signal is dependent on statistical analysis indicative of the blocking activity.

6. The method of claim 1, wherein the logging of a time stamp and a plurality of data values associated with the detected at least one blocker signal is executed in at least one remote unit.

7. The method of claim 1, wherein the logging of a time stamp and a plurality of data values associated with the detected at least one blocker signal is executed in at least one expansion hub.

8. The method of claim 1, wherein the logging of a time stamp and a plurality of data values associated with the detected at least one blocker signal is executed in at least one central hub.

9. Use of the method of claim 1 for alleviating effects of blocker signals, further comprising attenuating the at least one blocker signal in at least one remote unit connected to the at least one antenna element, whilst leaving other signals unattenuated.

10. The use of claim 7, wherein the attenuating of the at least one blocker signal is dependent on statistical analysis indicative of the blocking activity.

11. A system for analysing blocking activity in a distributed antenna system comprising:
a plurality of antenna elements connected to a plurality of remote units;
a monitor for monitoring presence of a blocker signal in one or more signals of the plurality of antenna elements;
a data logger for logging a plurality of data values associated with the at least one blocker signal; and
a data storage device for storing the logged plurality of data values.

12. The system of claim 11, wherein the plurality of data values comprise at least one of a frequency band, a carrier frequency, a time stamp, a power level and an antenna element designation

13. A network planning system connected to the system of claim 11.
